(19) United States
(12) Patent Application Publication
(10) Pub. No.: US 2011/0269067 A1
(43) Pub. Date: Nov. 3, 2011

(54) METHOD OF PREPARING TONER HAVING NARROW PARTICLE SIZE DISTRIBUTION

(75) Inventors: Moo Eon Park, Seoul (KR); Jae Bum Park, Daejeon-city (KR); Sung Yul Kim, Cheongju-si (KR); Jin Young Kim, Daejeon-city (KR); Kyoung Suk Cho, Daejeon-city (KR); Jae Kwang Hwang, Daejeon-city (KR); Young Jae Kwon, Daejeon-city (KR)

(73) Assignee: SAMSUNG FINE CHEMICALS CO., LTD., Ulsan-city (KR)

(21) Appl. No.: 13/143,079

(22) PCT Filed: Dec. 24, 2009
(86) PCT No.: PCT/KR09/07762

§ 371 Date: Jun. 30, 2011

(30) Foreign Application Priority Data
Dec. 31, 2008 (KR) 10-2008-0138537

(51) Int. Cl. G03G 9/08

(52) U.S. Cl. 430/137.14

(57) ABSTRACT

According to a method of preparing a toner by emulsion aggregation, viscosity of dispersions is controlled during an initial reaction by using an abietic acid so that a particle diameter distribution of the toner is narrowed.

### CROSS-REFERENCE TO RELATED PATENT APPLICATION

This application claims the benefit of Korean Patent Application No. 10-2008-0138537, filed on Dec. 31, 2008, in the Korean Intellectual Property Office, the disclosure of which is incorporated herein in its entirety by reference.

### BACKGROUND OF THE INVENTION

1. Field of the Invention

The present invention relates to a method of preparing a toner by emulsion aggregation, and more particularly, to a method of preparing a toner having excellent fixing characteristics and a narrow particle size distribution.

2. Description of the Related Art

In general, toner is prepared by adding a colorant, a charge controller, or a releasing agent to a thermoplastic resin acting as a binder resin. In addition, an outer additive such as an inorganic metal fine powder may be added to the toner in order to provide fluidity to the toner or improve physical properties of the toner, such as charge controlling or cleaning properties, wherein the inorganic metal fine powder may be silica or titanium oxide. Toner may be prepared using a physical method such as a pulverization method, or a chemical method such as a suspension and polymerization method or an emulsion aggregation method.

According to an emulsion aggregation method (refer to U.S. Pat. Nos. 5,916,725 and 6,268,103), a fine emulsion resin particle composition is prepared by emulsion polymerization and is then aggregated with, for example, a pigment in a dispersion. The emulsion aggregation method may improve problems of the pulverization method; for example, high costs and a wide particle size distribution. In addition, by using the emulsion aggregation method under controlled aggregation conditions spherical toner particles may be obtained.

The quality of an emulsion aggregation toner depends on raw materials used, that is, stability of a latex dispersion, a colorant dispersion, and a wax dispersion. The dispersions may be unstable when they are mixed during an initial reaction, and a phase separation may occur according to a time, temperature, or shear force during when the dispersions are mixed. When the mixed solution including the dispersions is unstable, the resultant toner may have a larger particle size, a wider particle size distribution, a higher sedimentation rate, and a wider molecular weight distribution. Such a toner has poor image fixability and an image formed using the toner has low quality, and thus is not preferred by consumers. Also, such a toner has a wide particle size distribution and thus production of the toner that can be used as a final product is reduced in the manufacturing process and the manufacturing yield is reduced.

### SUMMARY OF THE INVENTION

The present invention provides a method of preparing a toner by emulsion aggregation. According to the method, the stability of dispersions used to prepare the toner is increased and thus, a toner having a narrow particle size distribution is obtained.

According to an aspect of the present invention, there is provided a method of preparing toner, wherein the method includes: mixing a latex dispersion, a colorant dispersion, a wax dispersion, and an abietic acid; adding an aggregating agent to the mixture to aggregate the mixture, thereby forming toner particles; and fusing the formed toner particles.

The amount of the abietic acid may be in the range of 0.1 to 10 parts by weight based on 100 parts by weight of a total solid content of toner.

The abietic acid may be in a solution form prepared by dissolving an abietic acid in an alcohol.

The abietic acid may be extracted from a pine resin.

### DETAILED DESCRIPTION OF THE INVENTION

Hereinafter, exemplary embodiments of the present invention will be described in detail.

A method of preparing toner includes mixing a latex dispersion, a colorant dispersion, a wax dispersion, and an abietic acid; adding an aggregating agent to the mixture to aggregate the mixture, thereby forming toner particles; and fusing the formed toner particles.

The use of the abietic acid increases the stability of the latex dispersion, the colorant dispersion, and the wax dispersion during the mixing and thus reduces a particle size distribution of the resultant toner particles.

The amount of the abietic acid may be in the range of 0.1 to 10 parts by weight based on 100 parts by weight of the total toner solid powder. If the amount of the abietic acid is less than 0.1 parts by weight based on 100 parts by weight of a total solid content of toner, stabilization effects may be negligible. On the other hand, if the amount of the abietic acid is greater than 10 parts by weight based on 100 parts by weight of the total toner solid powder, the dispersion mixture may gelate.

The abietic acid may be in a solution form prepared by dissolving an abietic acid in an alcohol. The concentration of the abietic acid solution may be in the range of 0.1M to 1M. The abietic acid may be extracted from a pine resin.

According to the method of preparing a toner according to the present embodiment, the aggregating agent is added to a mixture including the latex dispersion, the colorant dispersion, the wax dispersion, and the abietic acid, and then the resultant mixture is homogenized and aggregated together, thereby preparing toner particles. That is, the latex dispersion, the colorant dispersion, the wax dispersion, and the abietic acid are loaded into a reactor and then the aggregating agent is added thereto. The resultant mixture is homogenized for 10 to 100 minutes at a pH of 1.5 to 2.3, at a temperature of 20 to 30° C., and at a stirring linear velocity of 1.0 to 2.0 m/s. Then, the temperature of the reactor is increased to be in the range of 48 to 53° C., and then aggregation is performed by stirring at a stirring linear velocity of 1.5 to 2.5 m/s.

An initial viscosity of the resultant mixture after the aggregating agent is added may be in the range of 82 to 161 cPs when measured using a Brookfield viscometer LV set No. 3 (25° C., 200 rpm.).

The aggregated toner particles are fused, cooled, and then dried, thereby obtaining desired toner particles. The dried toner particles are treated with an outer additive such as silica in order to control the amount of charge, thereby preparing a final toner for a laser printer.

The method according to the present embodiment may also be applied to a toner having a core-shell structure. When a toner having a core-shell structure is prepared, an aggregating agent is added to a mixture including a latex dispersion for a core, a colorant dispersion, a wax dispersion, and an abietic acid (solution) and then the resultant mixture is homogenized and aggregated, thereby preparing a primary aggregated toner. Then, a latex dispersion for a shell is added to the obtained primary aggregated toner to form a shell layer. Then, the resultant toner is fused.

The latex dispersion used in the method according to the present embodiment may include a binder resin. The binder resin may be prepared by polymerizing at least one type of polymerizable monomer selected from the group consisting of a vinyl monomer, a polar monomer having a carboxyl group, a monomer having an unsaturated ester group, and a monomer having an aliphatic group.

The polymerization described above may be performed using, in general, a polymerization initiator, and the polymerization initiator may be a benzoyl peroxide-based initiator or an azo-based polymerization initiator.

A macromonomer and a chain transfer agent may be further used to control a number average molecular weight and a glass transition temperature (Tg) of the binder resin, respectively. Examples of the macromonomer include polyethyleneglycol ethylether methacrylate, polyethyleneglycol methyl methacrylate, and polyethyleneglycol methyl acrylate. Examples of the chain transfer agent include divinyl benzene and 1-dodecanthiol.

The amount of the macromonomer may be in the range of 0.3 to 30 parts by weight based on 100 parts by weight of the binder resin.

Some of the binder resins described above may be further reacted with a cross-linker, and the cross-linker may be an isocyanate compound and an epoxy compound.

The colorant dispersion may include a colorant. The colorant may be a pigment itself, or may be used in the form of a pigment master batch obtained by dispersing a pigment in a resin.

The pigment may be selected from the group consisting of a black pigment, a cyan pigment, a magenta pigment, a yellow pigment, which are commercially used, and a mixture thereof.

The amount of the colorant may be such an amount where toner is colored and a visible image is formed by development. For example, the amount of the colorant may be in the range of 1 to 20 parts by weight based on 100 parts by weight of the binder resin.

Meanwhile, an additive used to prepare toner may be a charge controller or the like.

The charge controller may be a negative charge control agent or a positive charge control agent. The negative charge control agent may be any commercially known negative charge control agent. Examples of the negative charge control agent include an organometalic complex or chelate compound; a metal-containing salicylic acid compound; and organometalic complexes of aromatic hydroxycarboxylic acid and aromatic dicarboxylic acid. In addition, the positive charge control agent may include at least one type of material selected from the group consisting of a product reformed with nigrosine and an aliphatic metal salt of nigrosine, and an onium salt such as a quaternary ammonium salt. The charge controller stably and quickly charges toner with an electrostatic force and thus stably supports toner on a development roller.

The amount of the charge controller included in the toner may be in the range of 0.1 parts by weight to 10 parts by weight based on 100 parts by weight of an entire toner composition.

A wax improves fixability of a toner image, and may be a polyalkylene wax such as a low molecular weight polypropylene or a low molecular weight polyethylene, an ester wax, a carnauba wax, or a paraffin wax. The amount of the wax included in the toner may be in the range of 0.1 parts by weight to 30 parts by weight based on 100 parts by weight of the entire toner composition. If the amount of the wax is less than 0.1 parts by weight, oil-less fixation, that is, fixation without oil, may not be obtained. On the other hand, if the amount of the wax is greater than 30 parts by weight, the toner may lump during preservation.

The additive may further include an outer additive. The outer additive is used to improve fluidity of toner or to control charge characteristics of toner. Examples of the outer additive include large particle diameters of silica, small particle diameters of silica, and a polymer bead.

The present invention will be described in further detail with reference to the following examples. These examples are for illustrative purposes only and are not intended to limit the scope of the present invention.

### Example 1

### Preparation of Latex Dispersion

A reactor having a volume of 3 liters including a stirrer, a thermometer, and a condenser was installed in an oil vessel acting as a thermal transfer medium. 660 g of distilled water and 3.2 g of surfactant (Dowfax 2A1) were added to the reactor, the temperature of the reactor was increased to a temperature of 70° C., and stirring was performed thereon at a rate of 100 rpm. Then, 13.5 g of potassium persulfate was added thereto as a polymerization initiator. Then, an emulsion mixture including 838 g of styrene, 322 g of butyl acrylate, 37 g of 2-carboxyethyl acrylate, 22.6 g of 1,10-decandiol diacrylate acting as monomers, 507.5 g of distilled water, 22.6 g of surfactant (Dowfax 2A1), 53 g of polyethyleneglycol ethylether methacrylate acting as a micromonomer, and 18.8 g of 1-dodecanthiol acting as a chain transfer agent was stirred with a disc-type impeller at a rate of 400 to 500 rpm for 30 minutes and then the mixture was slowly loaded into the reactor for 1 hour. Then, the reaction was performed for about 8 hours and then stopped by slowly dropping the temperature to room temperature.

After the reaction was completed, a differential scanning calorimeter (DSC) was used to measure a glass transition temperature (Tg) of a binder resin. The Tg of the binder resin was 60° C. A number average molecular weight of the binder resin was measured by gel permeation chromatography (GPC) using polystyrene as a reference sample. The measured number average molecular weight of the binder resin was 70,000.

(Preparation of Colorant Dispersion)

540 g of cyan pigment (ECB303, a e Dainichiseika Color & Chemical Mfg. Co., Ltd product), 27 g of surfactant (Dowfax 2A1), and 2,450 g of distilled water were loaded into a reactor having a volume of 3 liters including a stirrer, a thermometer, and a condenser, and then the mixture was preliminary dispersed by slowly stirring for about 10 hours. Then, dispersing was performed thereon four times using Ultimaizer (produced by Amstek Co., Ltd) with a 1500 bar until the particle size was 200 nm or lower. As a result, a cyan pigment dispersion was obtained.

After the dispersion was completed, the particle diameter of the obtained cyan pigment particle was measured with Nanotrac (product of Microtrac Co., Ltd). The obtained D50(v) was 170 nm. In this regard, D50(v) refers to a particle diameter corresponding to 50% based on a volume average particle diameter, that is, a particle diameter corresponding to 50% of the total volume when particle diameters are measured and the volume of particles is accumulated from smaller particles.

(Preparation of Wax Dispersion)

1,910 g of ultra pure water and 40.8 g of surfactant (SDBS) were loaded into a reactor having a volume of 3 liters including a stirrer, a thermometer, and a condenser, and then the temperature of the reactor was increased to a temperature of 85° C. while stirring at room temperature. At the temperature of 85° C., the mixture was homogenized for 30 minutes and 800 g of wax (product name: P-787 and manufacturer: Chukyo Yushi Co. Ltd, Japan) was added to the reactor. After stirring was performed for 10 minutes, the temperature of the reactor was increased to a temperature of 110° C. and then maintained at the temperature of 110° C. for one hour. Then, the homogenizing process was performed five to six times by passing and when particles having a particle diameter of 200 to 300 nm were obtained, the mixture was cooled. After the dispersion was completed, the particle diameter of particles was measured with Nanotrac (product of Microtrac Co., Ltd). As a result, D50(v) was in the range of 200 to 300 nm.

(Preparation of Abietic Acid Solution)

An abietic acid (302.45 g/mol) (manufacturer: Sigma-Aldrich Inc., product name: abietic acid, Assay: 75%) was dissolved in ethanol to prepare a 1M abietic acid solution.

(Preparation of Toner Particles)

7,924 g of distilled water was added to a reactor having a volume of 20 liters and then 4.364 g of the prepared abietic acid solution (containing 1.760 g of the abietic acid) was added thereto. Then, 1,827 g (solid content 60%) of the prepared latex dispersion, 660 g (solid content 12%) of the prepared colorant dispersion, and 1,218 g (solid content 13%) of the prepared wax dispersion were added thereto and the resultant mixture was stirred at a rate of 120 rpm at room temperature. As an aggregating agent, 1,529 g (solid content 2%) of a mixture including 0.3N HNO₃ and poly silicato iron (PSI) in a mass ratio of 2:1 was added thereto. The temperature of the reactor was increased to a temperature of 57° C. and then, aggregation was performed by stirring at a rate of 140 rpm. The aggregation process was continuously performed until the D50 reached the range of 6.45 to 6.50 μm. After 2,842 g (solid content 15%) of the latex dispersion was added thereto, 950 g of 1N sodium hydroxide aqueous solution was loaded into the reactor and stirring was performed at a rate of 120 rpm until a pH of the mixture was 4 and at a rate of 100 rpm until a pH of the mixture was 7. Then, the temperature of the reactor was increased to 96° C. while the stirring speed was reduced to 80 rpm, thereby fusing toner particles. The fusing was continuously performed until a circularity of 0.970 was obtained.

Then, the temperature of the reactor was cooled to 40° C. and toner was isolated using a filtering device (name: a filter press), and the isolated toner was washed once with 0.3N HNO₃ aqueous solution and five times with distilled water to remove, for example, the surfactant. Then, the washed toner particles were dried at a temperature of 40° C. for five hours in a fluidized bed dryer, thereby obtaining dried toner particles.

### Example 2

Toner particles were obtained in the same manner as in Example 1, except that 218.2 g of the abietic acid solution was used.

### Example 3

Toner particles were obtained in the same manner as in Example 1, except that 436.4 g of the abietic acid solution was used.

### Comparative Example 1

Toner particles were obtained in the same manner as in Example 1, except that the abietic acid solution was not used.

Evaluation Method

Properties of the toner particles prepared according to Examples 1-3 and Comparative Example 1 were measured as follows.

(1) Initial Viscosity

Initial viscosity was measured using a Brookfield viscometer LV set No. 3 spindle. The initial viscosity was measured as follows. All the dispersions and the abietic acid solution were loaded into a reactor and then an aggregating agent was added thereto. The mixture was homogenized for 10 minutes to 100 minutes and at a temperature of 25° C. to 30° C. and then, some of the mixture was sampled. The temperature of the sample was adjusted to be 25° C. and then a viscosity value of the sample when the spindle was rotated at a rate of 200 rpm for one minute was measured.

(2) Particle Diameter Distribution

GSDp and GSDv of the toner particles prepared according to Examples 1-3 and Comparative Example 1 were obtained by measuring average particle diameters with a Multisizer™ 3 Coulter Counter® produced by Beckman Coulter Inc. and using Equations 1 and 2 below. The aperture of the Multisizer™ 3 Coulter Counter® was 100 μm. An appropriate amount of a surfactant was added to 50 to 100 ml of ISOTON-II (Beckman Coulter Co., Ltd) acting as an electrolyte, and then 10 to 15 mg of an evaluation sample was added thereto and then the mixture was dispersed by an ultrasonic disperser for 5 minutes, thereby preparing a sample.

$$\begin{matrix}GSDp = \sqrt{\frac{D 84 p}{D 16 p}} ( p \text{:} number of particles ) & [ Equation 1 ] \\ GSDv = \sqrt{\frac{D 84 v}{D 16 v}} ( v \text{:} volume ) & [ Equation 2 ]\end{matrix}$$

(3) Fixing Temperature Range

A toner composition was prepared by mixing 100 g of toner particles, 2 g of silica (product of TG 810G, Cabot), and 0.5 g of silica (Rx50, product of Degussa). Then, an unfixed image of a 30 mm×40 mm solid phase was obtained using the toner composition in a Samsung CLP-510 printer. Then, fixability of the unfixed image was evaluated while the temperature of a fixing roller was changed in a fixing tester that had been modified such that the fixing temperature is arbitrarily changed.

TABLE 1

| | | | | Comparative |
|---|---|---|---|---|
| | Example 1 | Example 2 | Example 3 | Example 1 |
| Initial viscosity (cps) | 82.3 | 133.2 | 160.7 | 80 |
| GSDp | 1.25 | 1.27 | 1.26 | 1.29~1.33 |
| GSDv | 1.22 | 1.22 | 1.22 | 1.24~1.26 |
| Fixing temperature | 130~200 | 130~200 | 130~200 | 150~200 |

As shown in Table 1, it can be seen that the dispersion mixtures used in Examples 1-3 during an initial reaction have higher viscosity than the dispersion mixture used in Comparative Example 1 during an initial reaction. Thus, this shows that the dispersions of Examples 1-3 have high stability. In addition, it can be seen that the toner particles prepared according to Examples 1-3 have a narrower particle diameter distribution and a wider fixing temperature range than the toner particles prepared according to Comparative Example 1.

In a method according to an embodiment of the present invention, a toner having a narrow particle diameter distribution is obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing toner, the method comprising:
mixing a latex dispersion, a colorant dispersion, a wax dispersion, and an abietic acid;
adding an aggregating agent to the mixture to aggregate the mixture, thereby forming toner particles; and
fusing the formed toner particles.

2. The method of claim 1, wherein the abietic acid is extracted from a pine resin.

3. The method of claim 1, wherein the abietic acid is in a solution form prepared by dissolving an abietic acid in an alcohol.

4. The method of claim 3, wherein a concentration of the abietic acid solution is in the range of 0.1M to 1M.

5. The method of claim 1, wherein the amount of the abietic acid is in the range of 0.1 to 10 parts by weight based on 100 parts by weight of a total solid content of toner.

6. The method of claim 1, wherein after the aggregating agent is added, an initial viscosity of the mixture is in the range of 82 to 161 cPs, wherein the initial viscosity is measured with a Brookfield viscometer at a temperature of 25° C. and at a rotational rate of 200 rpm.
